(19) United States
(12) Patent Application Publication
(10) Pub. No.: US 2008/0231555 A1
(43) Pub. Date: Sep. 25, 2008

(54) Plasma display panel

(76) Inventor: Jung-Tae Park, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/894,992

(22) Filed: Aug. 21, 2007

(30) Foreign Application Priority Data
Mar. 19, 2007 (KR) 10-2007-0026773

(51) Int. Cl. G09G 3/28

(52) U.S. Cl. 345/67

(57) ABSTRACT

A plasma display panel including: a first substrate and a second substrate facing each other; X electrodes and Y electrodes extending in a first direction between the first substrate and the second substrate; third electrodes extending in a second direction between the first substrate and the second substrate; barrier ribs arranged between the first substrate and the second substrate so as to define a plurality of discharge cells, wherein the barrier ribs comprise horizontal barrier ribs extending in the first direction; a first dielectric layer arranged on the first substrate so as to cover the X electrodes and the Y electrodes; a second dielectric layer arranged on the second substrate so as to cover the third electrodes, wherein each of the X electrodes and Y electrodes comprises a transparent electrode and a bus electrode, and a distance We between bus electrodes of adjacent discharge cells satisfies an about 4×Wb≦We≦ about 6×Wb relationship where Wb is the thickness of each horizontal barrier rib.

### CROSS-REFERENCE TO RELATED PATENT APPLICATION

This application claims the benefit of Korean Patent Application No. 10-2007-0026773, filed on Mar. 19, 2007, in the Korean Intellectual Property Office, the disclosure of which is incorporated herein in its entirety by reference.

### BACKGROUND OF THE INVENTION

1. Field of the Invention

The present embodiments relate to a plasma display panel (PDP), and more particularly, to a PDP capable of having a maximized aperture ratio and minimized crosstalk with a high definition and a high resolution.

2. Description of the Related Art

Plasma display panels (PDPs), which are being used as a replacement for conventional cathode ray tubes (CRTs), are display devices that display images by applying a discharge voltage to a discharge gas between two substrates with a plurality of electrodes formed on the substrates to generate ultraviolet (UV) rays, and exciting phosphor layers arranged in a predetermined pattern with the UV rays.

Typical alternating current (AC) PDPs include an upper plate that displays an image to users, and a lower plate that is coupled to, and parallel to, the upper plate. The front substrate of the upper plate includes sustain electrode pairs arranged thereon. The rear substrate of the lower plate includes address electrodes arranged on a surface facing the surface of the front substrate on which the sustain electrode pairs are arranged. The address electrodes intersect the sustain electrode pairs.

A first dielectric layer and a second dielectric layer are respectively formed on the surface of the front substrate, on which the sustain electrode pairs are arranged, and the surface of the rear substrate, on which the address electrodes are arranged, such that the sustain electrode pairs and the address electrodes are buried. A protection layer generally formed of MgO is arranged on a rear surface of the first dielectric layer. Barrier ribs, for maintaining a discharge distance between the opposing substrates and preventing an optical crosstalk between discharge cells, are arranged on the front surface of the second dielectric layer.

Red, green, and blue phosphors are appropriately coated on sidewalls of the barrier ribs and on the front surface of the second dielectric layer.

Each of the sustain electrode pairs includes a transparent electrode and a bus electrode. The transparent electrode is formed of a material that is a conductor capable of generating a discharge and is transparent so as not to prevent light emitted from the phosphors from propagating toward the front substrate. The transparent material may be indium tin oxide (ITO) or the like. The bus electrode may be typically a metal electrode having a high electric conductivity.

High-definition, high-resolution PDPs may provide low brightness because of small discharge cells. In order to solve this problem, the aperture ratio of discharge cells needs to be maximized. However, as the aperture ratio increases, the distance between electrodes of vertically adjacent discharge cells decreases.

However, the decrease of the inter-electrode distance between adjacent discharge cells may accelerate crosstalk between the adjacent discharge cells. The present embodiments solve this problem among others.

### SUMMARY OF THE INVENTION

The present embodiments provide a plasma display panel (PDP) that has an increased aperture ratio and a reduced generation of a crosstalk even when having small discharge cells in order to obtain a high definition and a high resolution, by limiting a distance between bus electrodes of vertically adjacent discharge cells.

According to an aspect of the present embodiments, there is provided a plasma display panel comprising: a first substrate and a second substrate facing each other; X electrodes and Y electrodes extending in a first direction between the first substrate and the second substrate; third electrodes extending in a second direction between the first substrate and the second substrate; barrier ribs arranged between the first substrate and the second substrate so as to define a plurality of discharge cells, wherein the barrier ribs comprise horizontal barrier ribs extending in the first direction; a first dielectric layer arranged on the first substrate so as to cover the X electrodes and the Y electrodes; a second dielectric layer arranged on the second substrate so as to cover the third electrodes, wherein each of the X electrodes and Y electrodes comprises a transparent electrode and a bus electrode, and a distance We between bus electrodes of adjacent discharge cells satisfies an about 4×Wb≦We≦ about 6×Wb relationship where Wb is the thickness of each horizontal barrier rib.

The plasma display panel may further comprise black stripes arranged on at least some portions of upper surfaces of the barrier ribs between the first substrate and the second substrate.

The first dielectric layer may be arranged on the first substrate so as to cover the X electrodes, the Y electrodes, and the black stripes.

The X electrodes and the Y electrodes may be arranged in adjacent discharge cells in the order of an X electrode, a Y electrode, an X electrode, and a Y electrode.

The X electrodes and the Y electrodes may be arranged in the discharge cells such that adjacent electrodes of adjacent discharge cells are both X electrodes or are both Y electrodes.

The barrier ribs may further comprise vertical barrier ribs extending in the second direction.

The plasma display panel may further comprise phosphor layers formed within the discharge cells, and a protection layer which covers a surface of the first dielectric layer that faces the second substrate, so as to protect the first dielectric layer.

According to another aspect of the present embodiments, there is provided a plasma display panel comprising: a first substrate and a second substrate facing each other; X electrodes and Y electrodes extending in a first direction between the first substrate and the second substrate; barrier ribs arranged between the first substrate and the second substrate so as to define a plurality of discharge cells, wherein the barrier ribs comprise horizontal barrier ribs extending in the first direction, wherein each of the X electrodes and Y electrodes comprises a transparent electrode and a bus electrode, and a distance We between bus electrodes of adjacent discharge cells satisfies an about 4×Wb≦We≦ about 6×Wb relationship where Wb is the thickness of each horizontal barrier rib.

In a PDP according to the present embodiments, a distance between bus electrodes of vertically adjacent discharge cells is limited, such that even when the discharge cells are diminished to obtain a high definition and a high resolution, the aperture ratio is increased, and generation of a crosstalk is reduced.

### BRIEF DESCRIPTION OF THE DRAWINGS

The above and other features and advantages of the present embodiments will become more apparent by describing in detail exemplary embodiments thereof with reference to the attached drawings in which:

FIG. 1 is a partially exploded perspective view of a plasma display panel (PDP) according to an embodiment;

FIG. 2 is a cross-section taken along line II-II of FIG. 1;

FIG. 3 is a cross-section of a PDP according to another embodiment, in which X electrodes and Y electrodes are arranged in a different order to the order of the PDP shown in FIGS. 1 and 2;

FIG. 4 is a partially exploded perspective view of a PDP including black stripes according to another embodiment;

FIG. 5 is a cross-section taken along line V-V of FIG. 4;

FIG. 6 is a cross-section of a PDP according to another embodiment, in which X electrodes and Y electrodes are arranged in a different order to the order of the PDP shown in FIGS. 4 and 5; and

FIG. 7 is a graph showing a crosstalk and a brightness variation versus a change of the distance between bus electrodes of adjacent discharge cells in a PDP according to the present embodiments.

### DETAILED DESCRIPTION OF THE INVENTION

The present embodiments will now be described more fully with reference to the accompanying drawings, in which exemplary embodiments are shown.

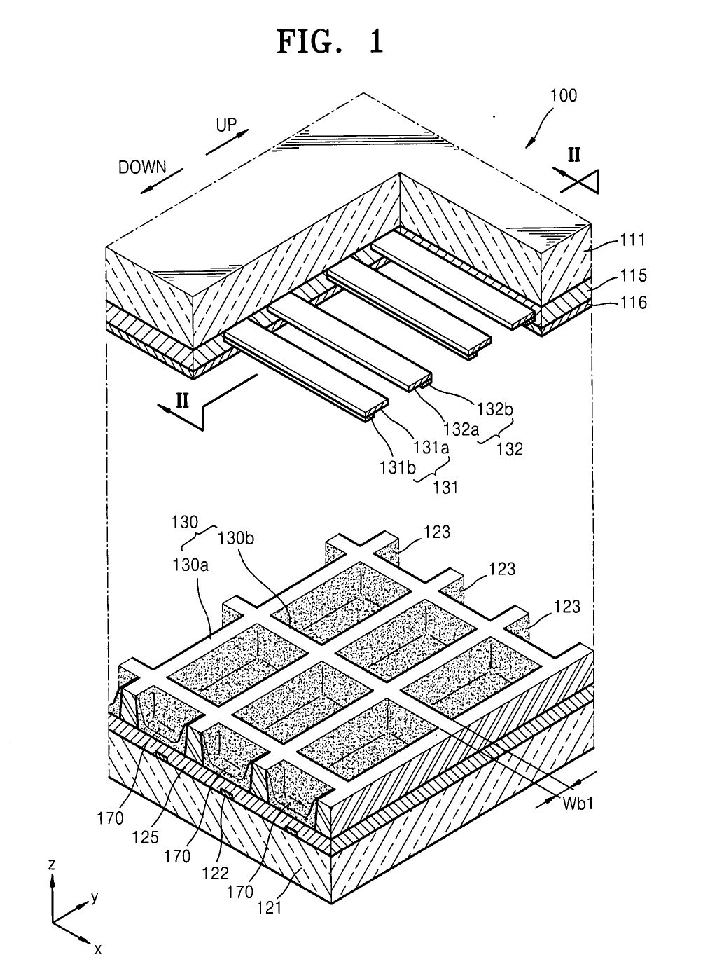

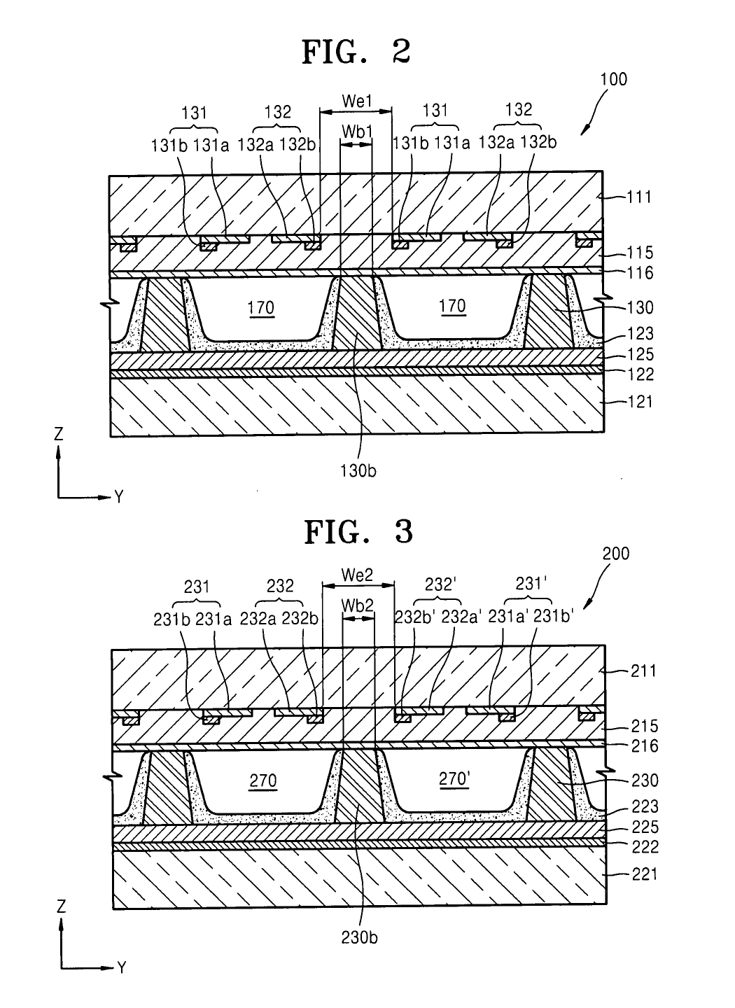

FIG. 1 is a partially exploded perspective view of a plasma display panel (PDP) 100 according to an embodiment. FIG. 2 is a cross-section taken along line II-II of FIG. 1. FIG. 3 is a cross-section of a PDP 200 according to another embodiment, in which X electrodes and Y electrodes are arranged in a different order to the order of the PDP 100 shown in FIGS. 1 and 2.

Referring to FIGS. 1 and 2, the PDP 100 is an alternating current (AC) type. The AC PDP 100 includes a first substrate 111, a second substrate 121, first and second electrodes 131 and 132, third electrodes 122, a barrier rib structure 130, a protection layer 116, phosphor layers 123, a first dielectric layer 115, a second dielectric layer 125, and a discharge gas (not shown).

The first substrate 111 may be a front substrate, and the second substrate 121 may be a rear substrate. The first and second electrodes 131 and 132 may constitute sustain electrode pairs that cause a sustain discharge. The third electrodes 122 may be address electrodes to which data pulses are applied to select discharge cells that are to generate a sustain discharge. The first dielectric layer 115 may be a front dielectric layer, and the second dielectric layer 125 may be a rear dielectric layer.

The front substrate 111 and the rear substrate 121 are arranged a predetermined distance apart from each other such as to face each other, and define a discharge space therebetween in which a discharge occurs. The front substrate 111 and the rear substrate 121 may be preferably formed of a material having a high visible transmittance such as glass. The front substrate 111 and/or the rear substrate 121 may also be colored to improve a bright room contrast.

The barrier rib structure 130 is arranged between the front substrate 111 and the rear substrate 121. Depending on the type of process, the barrier rib structure 130 may be arranged on the rear dielectric layer 125 between the front substrate 111 and the rear substrate 121. The barrier rib structure 130 divides the discharge space into a plurality of discharge cells 170 and prevents optical/electrical crosstalk between the discharge cells 170.

In FIG. 1, the barrier rib structure 130 defines a matrix of discharge cells with rectangular horizontal cross-sections. However, the present embodiments are not limited to the embodiment illustrated in FIG. 1. In other words, the barrier rib structure 130 may be designed so that the discharge cells 170 have horizontal cross-sections of a circle, an oval, or a polygon such as a triangle or a pentagon. Alternatively, the barrier rib structure 130 may be designed as an open structure, such as, strips. Alternatively, the discharge cells 170 of the barrier rib structure 130 may have a waffle or delta configuration.

The barrier rib structure 130 may include vertical barrier ribs 130a and horizontal barrier ribs 130b. In the drawings, the y direction is a vertical direction, and barrier ribs extending in the vertical direction y are the vertical barrier ribs 130a. Similarly, in the drawings, the x direction is a horizontal direction, and barrier ribs extending in the horizontal direction x are the horizontal barrier ribs 130b. Accordingly, each of the discharge cells 170 may be defined by a pair of vertical barrier ribs 130a adjacent to each other in the x direction and a pair of horizontal barrier rib 130b adjacent to each other in the y direction.

The pairs of sustain electrodes 131 and 132 are arranged on a surface of the front substrate 111 that faces the rear substrate 121, on the rear surface of the front substrate 111, in order to generate a sustain discharge. The sustain electrode pairs 131 and 132 are parallel to each other.

Each sustain electrode pair includes a first electrode 131, that is, a X electrode serving as a common electrode, and a second electrode 132, that is, a Y electrode serving as a scan electrode. Although the sustain electrode pairs are illustrated arranged on the front substrate 111 in the present embodiment, the location on which the sustain electrode pairs are arranged is not limited thereto. For example, the sustain electrode pairs may be arranged a predetermined interval apart from each other at some point between the front substrate 111 to the rear substrate 121.

Although a three-electrode structure is illustrated in the present embodiment, the present embodiments may be applied to a two-electrode structure in which each pair of sustain electrodes 131 and 132 is replaced by a single electrode.

The X electrodes 131 and the Y electrodes 132 respectively include transparent electrodes 131a and 132a, and bus electrodes 131b and 132b. The transparent electrodes 131a and 132a are formed of a transparent material that is a conductor capable of generating a discharge and is transparent so as to not prevent light emitted from the phosphor layers 123 from propagating toward the front substrate 111. This conductive and transparent material may be, for example, indium tin oxide (ITO) or the like.

However, a transparent conductor, such as ITO, generally has a high resistance. Hence, when only transparent electrodes are used to form the sustain electrodes, a voltage drop in the lengthwise direction of the sustain electrodes is large, such that a large amount of driving power is consumed and a response speed is low. In order to solve these problems, the bus electrodes 131b and 132b, being formed of a metal and having narrow widths, are arranged on the transparent electrodes 131a and 132a.

Two bus electrodes 131b and 132b are arranged a predetermined interval apart from each other in each discharge cell 170 such as to be parallel to each other, and extend across the discharge cell 170. As described above, the transparent electrodes 131a and 132a are electrically coupled to the bus electrodes 131b and 132b, respectively. The rectangular transparent electrodes 131a and 132a may be designed to be discontinuous between discharge cells 170. The transparent electrodes 131a and 132a are partially covered by the bus electrodes 131b and 132b, and the remaining parts of the transparent electrodes 131a and 132a face the centers of the discharge cells 170.

As illustrated in FIGS. 1 and 2, the X electrodes 131 and the Y electrodes 132 may be arranged in two adjacent discharge cells in the order of an X electrode 131, a Y electrode 132, an X electrode 131, and a Y electrode 132. A pair of X and Y electrodes 131 and 132 is arranged in each discharge cell 170 in the order of an X electrode 131 and a Y electrode 132, and this order is applied to all of the discharge cells 170.

In the PDP 100 having this electrode configuration, when an interval We1 between the bus electrodes 131b and 132b of two discharge cells adjacent to each other in the vertical direction y is smaller than a thickness Wb1 of each horizontal barrier rib 130b, crosstalk between discharge cells adjacent to each other in the vertical direction y may be generated during sustain discharge.

Hence, in the PDP 100, preferably, the interval We1 between the bus electrodes 131b and 132b of two discharge cells adjacent to each other in the vertical direction y satisfies an about 4×Wb1≦We1≦ about 6×Wb1 relationship where Wb1 is the thickness of each horizontal barrier rib 130b. In some embodiments, the interval We1 between the bus electrodes 131b and 132b of two discharge cells adjacent to each other in the vertical direction y is limited by the relationship of about 4×Wb1≦We1≦ about 6×Wb1, such that even when the discharge cells 170 are made small to obtain a high definition and a high resolution, the aperture ratio is increased and generation of a crosstalk is reduced.

According to the present embodiments, even when a high-definition, high-resolution PDP according to the present embodiments has small discharge cells, the PDP obtains a sufficient aperture ratio and secures a distance between vertically adjacent discharge cells, thereby preventing crosstalk and increasing the brightness.

In a PDP 200 according to another embodiment, as illustrated in FIG. 3, the X electrodes 231 and the Y electrodes 232 may be arranged in two adjacent discharge cells 270 in the order of an X electrode 231, a Y electrode 232, a Y electrode 232, and an X electrode 231. In other words, an X electrode 231 and a Y electrode 232 are arranged in the order of an X electrode 231 and a Y electrode 232 within discharge cells corresponding to one display line, and another X electrode 231 and another Y electrode 232 are arranged in the order of a Y electrode 232 and an X electrode 231 within discharge cells corresponding to a display line immediately adjacent to a display line with the X electrode 231 and Y electrode 232 order.

In the PDP 200 having this electrode configuration, for example, when an interval We2 between bus electrodes 232b and 232b′ of two discharge cells 270 and 270′ adjacent to each other in the vertical direction y is smaller than a thickness Wb2 of each horizontal barrier rib 230b, a Y electrode 232′ is scanned during an address period, and the next Y electrode 232 is then scanned. Hence, crosstalk between vertically adjacent discharge cells may be generated during an address discharge.

Hence, in the PDP 200, preferably, the interval We2 between the bus electrodes 232b and 232b′ of two discharge cells adjacent to each other in the vertical direction y satisfies an about 4×Wb2≦We2≦ about 6×Wb2 relationship where Wb2 is the thickness of each horizontal barrier rib 230b. In some embodiments, the interval We2 between the bus electrodes 232b and 232b′ of the two vertically adjacent discharge cells is limited to the relationship of about 4×Wb2≦We2≦ about 6×Wb2, such that even when the discharge cells 270 are made small to obtain a high definition and a high resolution, the aperture ratio is increased and generation of a crosstalk is reduced.

According to the present embodiments, even when a high-definition, high-resolution PDP according to the present embodiments has small discharge cells, the PDP has a sufficient aperture ratio and secures a distance between vertically adjacent discharge cells, thereby preventing crosstalk and increasing the brightness.

Each display line may be defined by each sustain electrode pair including one X electrode 231 and one Y electrode 232. Referring to FIG. 3, X electrodes 231 are adjacent to each other in some adjacent display lines. The bus electrodes 231b of adjacent X electrodes 231 are shared, and transparent electrodes 231a corresponding to display lines may extend in the direction of each display line.

The PDP 200 shown in FIG. 3 is the same as the PDP 100 shown in FIGS. 1 and 2 except for the arrangement of the X electrodes 231 and Y electrodes 232. Therefore, the same elements as those of the PDP 100 other than the aforementioned elements are indicated by similar elements and will not be described again.

Referring again to FIGS. 1 and 2, the front dielectric layer 115 is arranged on the front substrate 111 to bury the pairs of sustain electrodes 131 and 132. The front dielectric layer 115 prevents electrical conduction between adjacent X electrodes 131 and Y electrodes 132 and prevents the X and Y electrodes 131 and 132 from being damaged due to collisions of charged particles or electrons with the X and Y electrodes 131 and 132. The front dielectric layer 115 induces electrical charges. The front dielectric layer 115 can comprise, for example, PbO, B₂O₃, SiO₂, or the like.

Preferably, the PDP 100 further includes the protection layer 116 covering the front dielectric layer 115. The protection layer 116 prevents the front dielectric layer 115 from being damaged due to collisions of charged particles or electrons with the front dielectric layer 115 during a discharge.

The protection layer 116 also emits many secondary electrons during a discharge, thereby facilitating a plasma display. The protection layer 116 having the aforementioned functions is formed of a material that has a high secondary electron emission coefficient and a high visible transmittance. The protection layer 116 is formed thinly by generally sputtering or electron beam deposition after the formation of the front dielectric layer 115.

The third electrodes 122, namely, address electrodes, are arranged on a surface of the rear substrate 121 that faces the front substrate 111. The address electrodes 122 extend across the discharge cells 170 and intersect the X electrodes 131 and the Y electrodes 132.

The address electrodes 122 generate an address discharge in order to facilitate a sustain discharge between the X and Y electrodes 131 and 132 in discharge cells where a sustain discharge is to occur. More specifically, the address electrodes 122 lower the voltage used to generate a sustain discharge. An address discharge is generated between the Y electrodes 132 and the address electrodes 122. When the address discharge is concluded, wall charges are accumulated on the Y electrodes 132 and the X electrodes 131, such that the sustain discharge between the X electrodes 131 and the Y electrodes 132 is more easily generated.

Each space defined by a pair of an X electrode 131 and a Y electrode 132 and an address electrode 122 intersecting the X and Y electrodes 131 and 132 is a discharge cell 170.

The rear dielectric layer 125 is arranged on the rear substrate 121 and covers the address electrodes 122. The rear dielectric layer 125 is formed of a dielectric material that can prevent the address electrodes 122 from being damaged due to collisions of charged particles or electrons with the address electrodes 122 during a discharge and induce electrical charges. Examples of the dielectric material include PbO, B₂O₃, SiO₂, and the like.

The red, green, and blue phosphor layers 123 are arranged on side walls of the barrier rib structure 130 and on a portion of the front surface of the rear dielectric layer 125 that is not covered by the barrier rib structure 130. The phosphor layers 123 include a component that generates visible light in response to UV light. The red phosphor layers 123 include a phosphor such as Y(V,P)O₄:Eu, the green phosphor layers 123 include a phosphor such as Zn₂SiO₄:Mn or YBO₃:Tb, and the blue phosphor layers 123 include a phosphor such as BAM:Eu.

The discharge cells 170 are filled with a discharge gas in which neon (Ne), xenon (Xe), etc. are mixed. After the discharge cells 170 are filled with the discharge gas, a sealing member such as frit glass is formed on edges of the front substrate 111 and the rear substrate 121 in order to seal the front substrate 111 and the rear substrate 121 together.

UV light is emitted due to a decrease in the energy level of the discharge gas excited during a sustain discharge. The UV light excites the phosphor layers 123 formed within the discharge cells 170. Due to a subsequent decrease in the energy level of the phosphor layers 123, visible light is emitted and passes through the front dielectric layer 115 and the front substrate 111, thereby forming an image recognizable by a user.

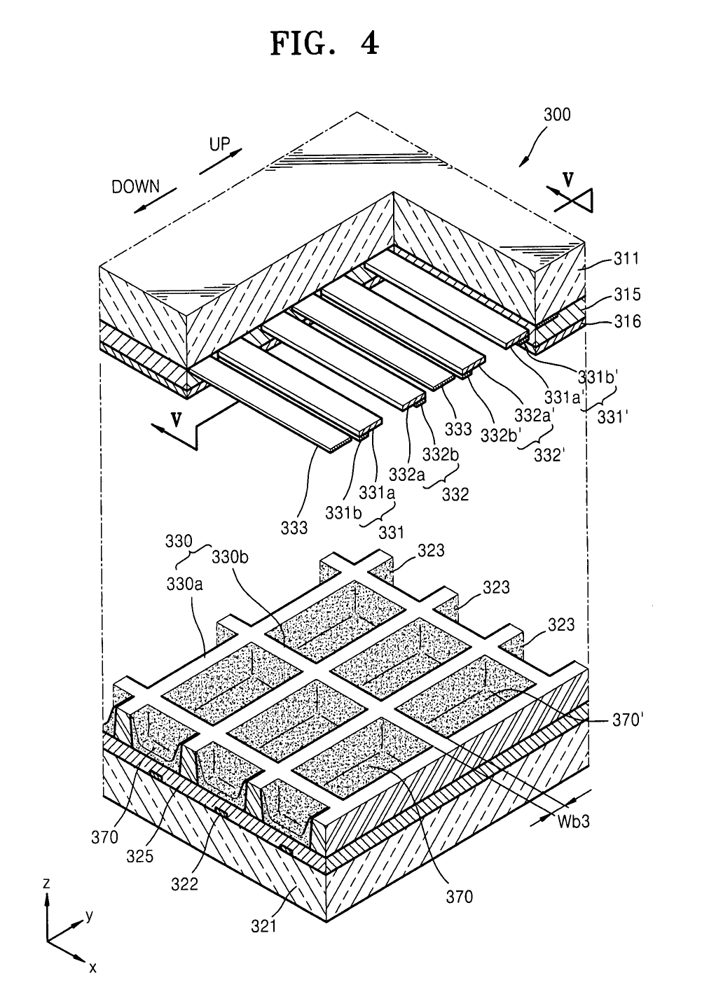

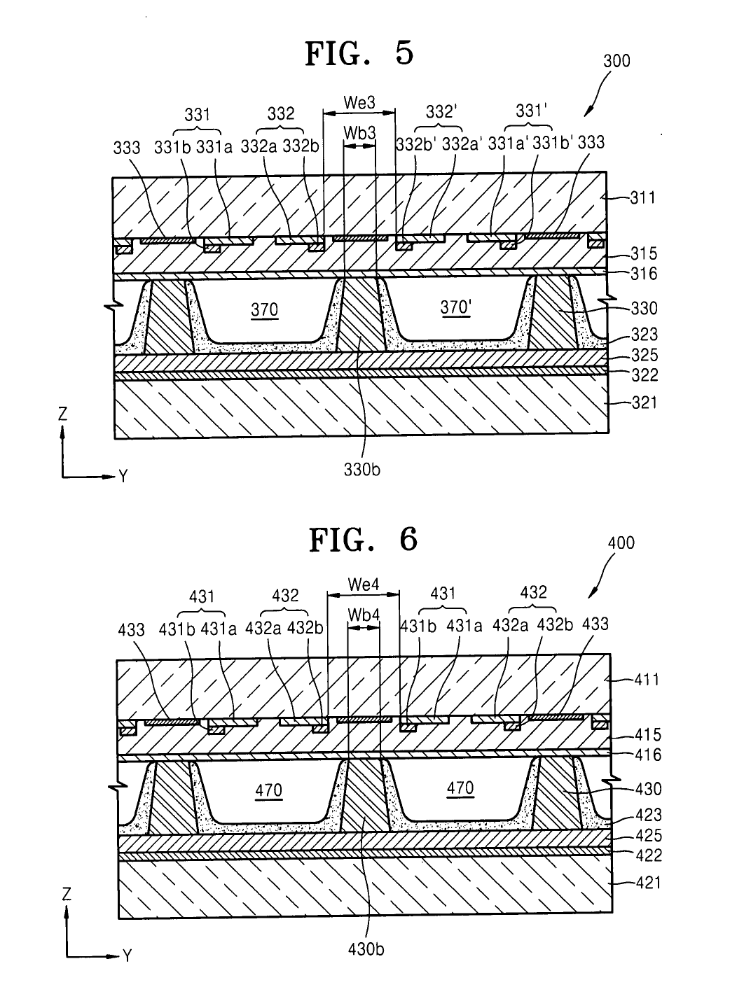

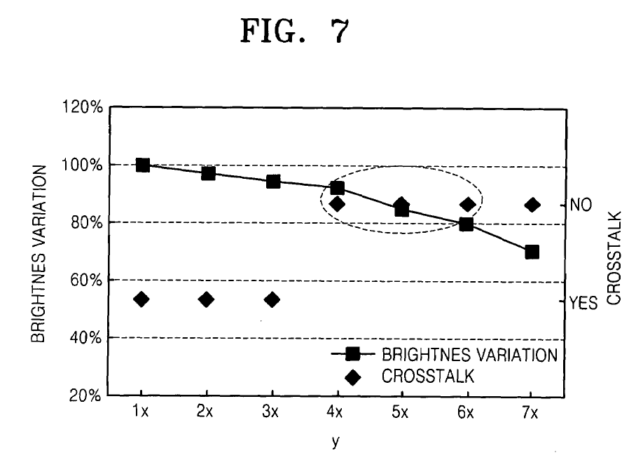

FIG. 4 is a partially exploded perspective view of a PDP 300 according to another embodiment, the PDP 300 including black stripes 333. FIG. 5 is a cross-section taken along line V-V of FIG. 4. FIG. 6 is a cross-section of a PDP 400 according to another embodiment, in which X electrodes and Y electrodes are arranged in a different order to the PDP 300 of FIGS. 4 and 5.

Referring to FIGS. 4 and 5, the PDP 300 includes a first substrate 311, a second substrate 321, barrier ribs 330, first and second electrodes 331 and 332, black stripes 333, third electrodes 322, a protection layer 316, phosphor layers 323, a first dielectric layer 315, a second dielectric layer 325, and a discharge gas (not shown). The embodiments illustrated in FIGS. 4 through 6 further include black stripes 333 as compared with the embodiments illustrated in FIGS. 1 through 3. Components of the embodiments of FIGS. 4 and 6 other than the black stripes 333 are the same as those of the embodiments illustrated in FIGS. 1 and 3 and are indicated by like references. To avoid repetition, detailed description of elements described with reference to the previous embodiments will be omitted.

The first substrate 311 may be a front substrate, and the second substrate 321 may be a rear substrate. The first and second electrodes 331 and 332 constitute sustain electrode pairs that generate a sustain discharge. The third electrodes 322 may be address electrodes to which data pulses are applied to select discharge cells where a sustain discharge is to be generated.

The first dielectric layer 315 may be a front dielectric layer, and the second dielectric layer 325 may be a rear dielectric layer. The first dielectric layer 315 is arranged on the first substrate 311 and covers the first electrodes 331, namely, X electrodes, the second electrodes 332, namely, Y electrodes, and the black stripes 333.

The black stripes 333 are arranged on at least some areas of the upper surfaces of the barrier ribs 330 arranged between the first substrate 311 and the second substrate 321, and absorb external incident light that is incident from outside of the PDP 300. The black stripes 333 preferably have a black-family color with a high light absorption in order to absorb external incident light. Since the black stripes 333 absorb external incident light, the PDP 300 may have an improved bright room contrast.

The black stripes 333 may be formed of a nonconductor in contrast with bus electrodes 332b and 332b′ of the Y electrodes 332. In this case, the black stripes 333 having a different dielectric constant from the dielectric material of the first dielectric layer 315 are arranged between the Y electrodes 332 and the Y electrodes 332′ of adjacent discharge cells.

When an electric field is formed between the bus electrodes 332b and 332b′ of adjacent Y electrodes, the electric field is maintained over the black stripes 333. In some embodiments, when a distance We3 between the bus electrodes 332b and 332b′ of vertically adjacent discharge cells is small, crosstalk is easily generated. When a distance We3 between the bus electrodes 332b and 332b′ of vertically adjacent discharge cells is small, crosstalk is easily generated.

Alternatively, when the black stripes 333 are formed of the same material as that of the bus electrodes 332b and 332b′, the black stripes 333 can be formed simultaneously with the bus electrodes 332b and 332b′. When the black stripes 333, being a conductor, are formed between adjacent bus electrodes 332b and 332b′, an electrical field being a half of the field formed between the bus electrodes 332b and 332b′ is formed on the black stripes 333. Hence, in this case, it is easy that a crosstalk is generated between adjacent discharge cells.

Particularly, in this case, the interval We3 between the bus electrodes 332b and 332b′ of two discharge cells adjacent to each other in the vertical direction y should satisfy an about 4×Wb3≦We3≦ about 6×Wb3 relationship where Wb3 is the thickness of each horizontal barrier rib 330b. Hence, even when the discharge cells 370 are made small to obtain a high definition and a high resolution, the aperture ratio is increased and generation of a crosstalk is reduced.

A restriction of a distance We4 between bus electrodes 432b of vertically adjacent discharge cells to a thickness Wb4 of each horizontal barrier rib 430b may also be applied to a PDP 400 shown in FIG. 6, in which X electrodes 431 and Y electrodes 432 in adjacent discharge cells are arranged in the order of an X electrode 431, a Y electrode 432, an X electrode 431, and a Y electrode 432.

FIG. 7 is a graph showing crosstalk and brightness variation versus a change of the distance between bus electrodes of adjacent discharge cells in a PDP according to the present embodiments.

Referring to FIG. 7, in a PDP according to the present embodiments, a distance y between bus electrodes of two vertically adjacent discharge cells preferably satisfies an about 4×x≦y≦ about 6×x relationship where x is the thickness of each horizontal barrier rib. In some embodiments, the distance y between the bus electrodes of the two vertically adjacent discharge cells is limited to the relationship of about 4×x≦y≦ about 6×x, such that even when the discharge cells are made small to obtain a high definition and a high resolution, the aperture ratio is increased and generation of a crosstalk is reduced.

In FIG. 7, brightness variation is represented as a percentage of a brightness when the distance y between the bus electrodes of adjacent discharge cells is the same as the thickness x of each horizontal barrier rib. Crosstalk denotes crosstalk generated according to the distance y between the bus electrodes of adjacent discharge cells.

In some embodiments, a discharge space exists between each horizontal barrier rib and each bus electrode, and visible light is also generated over the discharge spaces. When the distance y between the bus electrodes of adjacent discharge cells with respect to a barrier rib increases, the aperture ratio decreases accordingly, so that the brightness is lowered.

According to the present embodiments, even when a high-definition, high-resolution PDP has small discharge cells, it secures a sufficient aperture ratio and distance between vertically adjacent discharge cells, thereby preventing generation of crosstalk and increasing the brightness.

In the PDP according to the present embodiments, the distance between bus electrodes of vertically adjacent discharge cells is limited, such that even when the discharge cells are diminished to obtain a high definition and a high resolution, generation of crosstalk is prevented and the brightness is increased.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A plasma display panel comprising:
a first substrate and a second substrate facing each other;
X electrodes and Y electrodes extending in a first direction between the first substrate and the second substrate;
third electrodes extending in a second direction between the first substrate and the second substrate;
barrier ribs arranged between the first substrate and the second substrate configured to define a plurality of discharge cells, wherein the barrier ribs comprise horizontal barrier ribs extending in the first direction;
a first dielectric layer arranged on the first substrate configured to cover the X electrodes and the Y electrodes;
a second dielectric layer arranged on the second substrate configured to cover the third electrodes,
wherein each of the X electrodes and Y electrodes comprises a transparent electrode and a bus electrode, and wherein the distance We between bus electrodes of adjacent discharge cells satisfies an about 4×Wb≦We≦ about 6×Wb relationship where Wb is the thickness of each horizontal barrier rib.

2. The plasma display panel of claim 1, further comprising black stripes arranged on at least one portion of upper surfaces of the barrier ribs between the first substrate and the second substrate.

3. The plasma display panel of claim 2, wherein the black stripes are formed of the same material as the bus electrodes.

4. The plasma display panel of claim 2, wherein the black stripes are formed of a different material from the bus electrodes.

5. The plasma display panel of claim 2, wherein the first dielectric layer is arranged on the first substrate configured to cover the X electrodes, the Y electrodes, and the black stripes.

6. The plasma display panel of claim 1, wherein the X electrodes and the Y electrodes are arranged in adjacent discharge cells in the order of an X electrode, a Y electrode, an X electrode, and a Y electrode.

7. The plasma display panel of claim 1, wherein the X electrodes and the Y electrodes are arranged in the discharge cells such that adjacent electrodes of adjacent discharge cells are both X electrodes or are both Y electrodes.

8. The plasma display panel of claim 1, wherein the barrier ribs further comprise vertical barrier ribs extending in the second direction.

9. The plasma display panel of claim 1, further comprising:
phosphor layers formed within the discharge cells; and
a protection layer covering the surface of the first dielectric layer that faces the second substrate, configured to protect the first dielectric layer.

10. The plasma display panel of claim 9, wherein the protection layer is MgO.

11. A plasma display panel comprising:
a first substrate and a second substrate facing each other;
X electrodes and Y electrodes extending in a first direction between the first substrate and the second substrate;
barrier ribs arranged between the first substrate and the second substrate configured to define a plurality of discharge cells, wherein the barrier ribs comprise horizontal barrier ribs extending in the first direction,
wherein each of the X electrodes and Y electrodes comprises a transparent electrode and a bus electrode, and wherein the distance We between bus electrodes of adjacent discharge cells satisfies an about 4×Wb≦We≦ about 6×Wb relationship where Wb is the thickness of each horizontal barrier rib.

12. The plasma display panel of claim 11, further comprising black stripes arranged on at least some portions of upper surfaces of the barrier ribs between the first substrate and the second substrate.

13. The plasma display panel of claim 12, wherein the black stripes are formed of the same material as a material of the bus electrodes.

14. The plasma display panel of claim 11, wherein the black stripes are formed of a material different from the material of the bus electrodes.

15. The plasma display panel of claim 12, further comprising:
third electrodes extending in a second direction between the first substrate and the second substrate;
a first dielectric layer arranged on the first substrate configured to cover the X electrodes, the Y electrodes, and the black stripes; and
a second dielectric layer arranged on the second substrate configured to cover the third electrodes.

16. The plasma display panel of claim 11, wherein the X electrodes and the Y electrodes are arranged in adjacent discharge cells in the order of an X electrode, a Y electrode, an X electrode, and a Y electrode.

17. The plasma display panel of claim 11, wherein the X electrodes and the Y electrodes are arranged in the discharge cells such that adjacent electrodes of adjacent discharge cells are both X electrodes or are both Y electrodes.

18. The plasma display panel of claim 11, wherein the barrier ribs further comprise vertical barrier ribs extending in the second direction.

19. The plasma display panel of claim 11, further comprising:
third electrodes extending in a second direction between the first substrate and the second substrate;
a first dielectric layer arranged on the first substrate configured to cover the X electrodes and the Y electrodes; and
a second dielectric layer arranged on the second substrate configured to cover the third electrodes.

20. The plasma display panel of claim 11, further comprising:
phosphor layers formed within the discharge cells; and
a protection layer covering a surface of the first dielectric layer that faces the second substrate, configured to protect the first dielectric layer.

21. The plasma display panel of claim 20, wherein the protection layer is MgO.
